(19) United States
(12) Patent Application Publication
(10) Pub. No.: US 2008/0198154 A1
(43) Pub. Date: Aug. 21, 2008

(54) IMAGE PROCESSING APPARATUS AND METHOD FOR SUPPORTING OPERATION OF IMAGE PROCESSING APPARATUS

(75) Inventors: Sunao Tabata, Shizuoka-ken (JP); Haruhiko Ishida, Tokyo (JP); Masao Yamaguchi, Tokyo (JP); Takahiro Fuchigami, Kanagawa-ken (JP); Hiroyuki Kato, Shizuoka-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/676,332

(22) Filed: Feb. 19, 2007

(51) Int. Cl. G06F 17/00

(52) U.S. Cl. 345/418

(57) ABSTRACT

An image processing apparatus of the invention has an object to provide an image processing apparatus enabling the user to improve the operation ability even when furnished with a wide variety of capabilities, and a method for supporting an operation of the image processing apparatus, which is formed by including: an instruction unit configured to provide plural operation instructions to a user by displaying one of plural operation screens and plural operation items; an operation skill level calculation unit configured to calculate a level of skill of the user for an operation instructed by the instruction unit for one of each operation screen and each operation item displayed by the instruction unit according to an operation by the user; and an operation support unit configured to support the operation instructed by the instruction unit according to the level of skill calculated by the operation skill level calculation unit.

### BACKGROUND OF THE INVENTION

1. Field of the Invention

The present invention relates to a technique for supporting an operation of an image processing apparatus, and more particularly, to an image processing apparatus and a method for supporting an operation of the image processing apparatus for providing a support of an operation that matches the level of skill of the user.

2. Description of the Related Art

Recently, sophistication of a digital electronic device, such as an image processing apparatus, makes a problem obvious that the capabilities, operations involved with the capabilities, and a combination of the capabilities are becoming more complex. For example, for complex image processing apparatus called MFP (Multi Function Peripherals), the user has to bring original documents directly to the apparatus and give an operation instruction while standing except for a part of the capabilities, such as the printer capability. This makes mental and physical stress derived from the complexity of operations far larger than a personal computer or the like. As a method for addressing such an operation problem, there have been disclosed several support techniques.

For example, Patent Document 1 (JP-A-9-152926) discloses a support technique, by which the level of skill of the operator is determined from time intervals of input operations using keys, a pointing device, or the like and the number of erroneous inputs per unit time, and increases the frequency at which the guided input capability for displaying a job content the operator is supposed to perform next is provided for a less experienced operator. Also, Patent Document 2 (JP-A-2000-47532) discloses a support technique, by which the level of skill is calculated from an average value of time intervals of key input operations so as not only to set a display screen that matches the level of skill for each operator, but also to set a display screen having a content in light of the eyesight or the age of the operator by specifying the level of skill of the operator.

The support technique disclosed in Patent Document 1 relates to the guided input capability to provide a support at the level that matches the level of skill of the user, and because the number of items set for a particular operation capability and the setting procedure of this guided input capability are limited, this technique is effective for a job that needs inputs step by step in order; however, in the case of the user interface with which a large number of items can be inputted in parallel and the user does not necessarily have to set all the items as with an MFP, the guided input capability has the opposite effect of making the input operations more complex. For example, in a case where the default value that is initially set in the MFP is adopted unless the user gives a setting instruction, input operations possibly become more complex because of the guided input capability.

In addition, the technique disclosed in Patent Document 2 concerns about the typical user interface of the MFP. However, changing display screens correspondingly to the level of skill means that a screen totally different from the one displayed last is displayed when the level of skill of the operator changes. This may possibly throw the user into confusion and an operation may time take longer locally.

Further, both the techniques of Patent Document 1 and Patent Document 2 determine the level of skill on the basis of time intervals of key input operations or the like. However, even with a well experienced operator, time intervals of key input operations may possibly become longer for an operation capability he seldom uses. In addition, time intervals of key input operations vary with an operation capability being chosen and input information involved (for example, information about a choice between two or character inputs, such as an address). It is therefore impossible to determine the level of skill correctly unless the time intervals of key input operations in light of the operation capability being chosen and input information involved are applied. As a result, there is case where a support capability undesirable for the user is added, which contrarily makes operations easier without the guided input capability.

### SUMMARY OF THE INVENTION

The invention was devised to solve the problems discussed above, and has an object to provide an image processing apparatus enabling the user to improve the operation ability without throwing the user into confusion even when furnished with a wide variety of capabilities, and a method for supporting an operation of the image processing apparatus.

In order to solve the problems discussed above, an image processing apparatus of the invention includes: an instruction unit configured to provide plural operation instructions to a user by displaying one of plural operation screens and plural operation items; an operation skill level calculation unit configured to calculate a level of skill of the user for an operation instructed by the instruction unit for one of each operation screen and each operation item displayed by the instruction unit according to an operation by the user; and an operation support unit configured to support the operation instructed by the instruction unit according to the level of skill calculated by the operation skill level calculation unit.

Also, another image processing apparatus of the invention includes: instruction means for providing plural operation instructions to a user by displaying one of plural operation screens and plural operation items; operation skill level calculation means for calculating a level of skill of the user for an operation instructed by the instruction means for one of each operation screen and each operation item displayed by the instruction means according to an operation by the user; and operation support means for supporting the operation instructed by the instruction means according to the level of skill calculated by the operation skill level calculation means.

Further, the invention is a method for supporting an operation of an image processing apparatus that causes a computer in the image processing apparatus to provide a support of an operation of the image processing apparatus, including the steps of: providing plural operation instructions to a user by displaying one of plural operation screens and plural operation items; calculating a level of skill of the user for an operation instructed in the step of providing instructions for one of each operation screen and each operation item; and supporting the operation instructed in the step of providing instructions according to the level of skill calculated in the step of calculating the operation skill level.

### DESCRIPTION OF THE DRAWINGS

FIG. 1 is a view showing the configuration of an image processing apparatus according to a first embodiment of the invention;

FIG. 2(a) is a view showing a first example of the screen shown on a touch panel;

FIG. 2(b) is a view showing a second example of the screen shown on the touch panel;

FIG. 2(c) is a view showing a third example of the screen shown on the touch panel;

FIG. 2(d) is a view showing a fourth example of the screen shown on the touch panel;

FIG. 2(e) is a view showing a fifth example of the screen shown on the touch panel;

FIG. 3 is a view showing an example of items and the classification of categories on the screen of the touch panel shown in FIG. 2;

FIG. 4 is a flowchart detailing the flow of an operation of a display control unit 62 in the image processing apparatus of the first embodiment shown in FIG. 1;

FIG. 5(a) is a display screen of Advice Type 1 displayed on the touch panel:

FIG. 5(b) is a display screen of Advice Type 2 displayed on the touch panel;

FIG. 6 is a view showing the configuration of an image processing apparatus according to a second embodiment of the invention;

FIG. 7(a) shows a display screen of Advice Type for a less experienced user displayed on the touch panel by the level of skill;

FIG. 7(b) shows a display screen of Advice Type for a well experienced user displayed on the touch panel by the level of skill;

FIG. 8 is a flowchart detailing the flow of an operation of a display control unit in the image processing apparatus of the second embodiment shown in FIG. 6;

FIG. 9 is a view showing an example of the display on a touch panel of an image processing apparatus according to a third embodiment of the invention; and

FIG. 10 is a view showing the configuration of an image processing apparatus according to a fourth embodiment of the invention.

### DESCRIPTION OF THE EMBODIMENTS

Hereinafter, some embodiments of an image processing apparatus of the invention will be described in detail with reference to the drawings. Like components are labeled with like reference numerals in the drawings used in the respective embodiments, and descriptions will not be repeated to the possible extent.

### First Embodiment

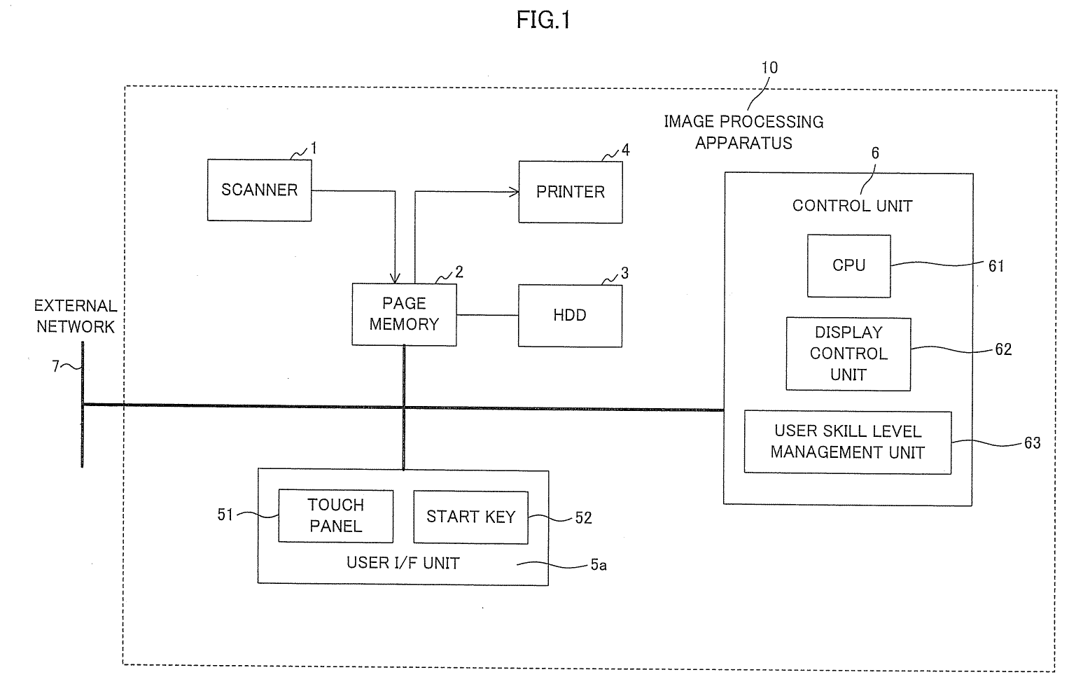

FIG. 1 is a view showing the configuration of an image processing apparatus according to a first embodiment of the invention. An image processing apparatus 10 is formed of a scanner 1 to input an image signal, a page memory 2 to store the image signal therein, a hard disc (HDD) 3, a printer 4 that prints image data, a user interface (user I/F) unit 5a provided with a touch panel 51 with which the user provides an operation instruction and a start key 52, and a control unit 6 that controls the image processing apparatus 10 entirely, all of which are connected to an external network 7. The control unit 6 includes a CPU 61, a display control unit 62, and a user skill level management unit 63.

Operations of the image processing apparatus 10 shown in FIG. 1 will now be described. The user places an original document on the scanner 1, chooses necessary capabilities according to the information displayed on the touch panel 51 of the user I/F unit 5a, and inputs necessary information to use the capability thus chosen. Execution of the desired job is started when the user depresses the start key 52.

The display control unit 62 of the control unit 6 measures the initial input start time from the touch panel 51, time intervals of operations on the touch panel 51, a depression time of the start key 52, and so forth, and displays information necessary to operate the touch panel 51 according to the items being operated and the measurement results. Computations necessary for the display control unit 62 in this instance are performed by the CPU 61.

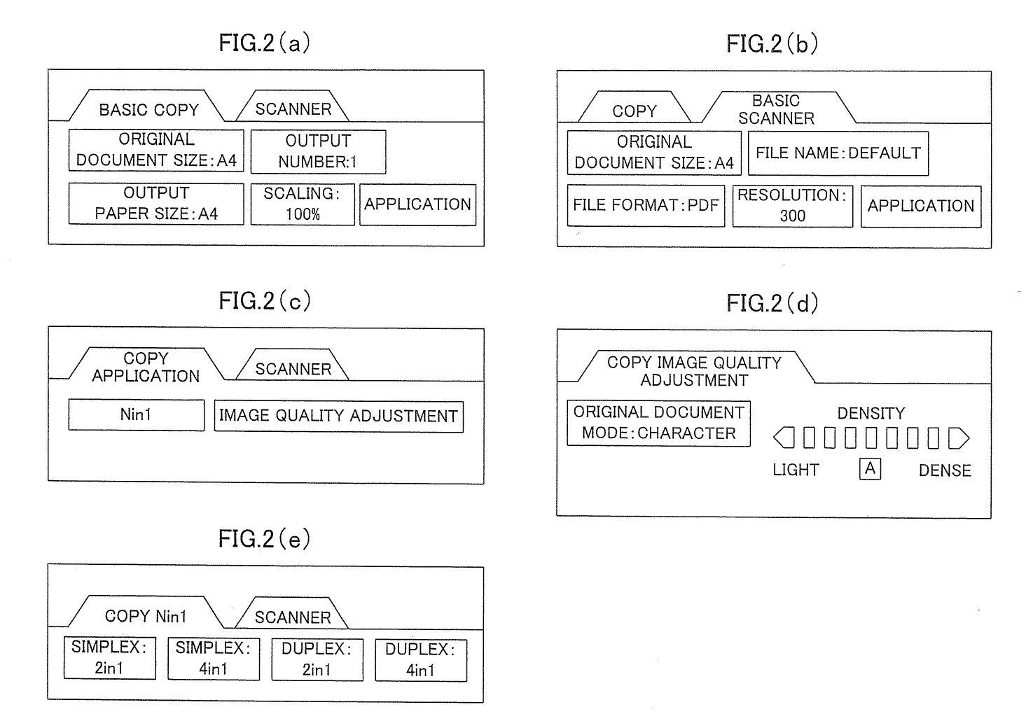

FIG. 2 is a view showing an example of the screen shown on the touch panel 51 of the image processing apparatus shown in FIG. 1. FIG. 2(a) through FIG. 2(e) show first through fifth examples of the screen, respectively. More specifically, as are shown in FIGS. 2(a) through 2(e), information displayed on the touch panel 51 of the user I/F unit 5a by the operations described above is configured in such a manner that basic items are set by the unit of capability, such as copying and scanning, while enabling further fine adjustments in a hierarchical fashion.

For example, as is shown in FIG. 2(a), when “Basic Copy” is set as a basic item, it is possible to further set, Original Document size: A4, Output Paper Size: A4, Output Number: 1, Scaling: 100%, and so forth.

As is shown in FIG. 2(b), when “Basic Scanner” is set as the basic item, it is possible to further set, Original Document Size: A4, File Name: Default, File Format: PDF, Resolution: 300, and so forth.

As is shown in FIG. 2(c), when “Applied Copy” is set as the basic item, it is possible to choose, as detailed settings, N in 1 (the capability to copy N original documents into a signal sheet of paper, for example, let N be 2, then 2 in 1, and let N be 4, then 4 in 1, which respectively mean that two original documents are copied in a signal sheet of paper and four original documents are copied in a single sheet of paper), image adjustment, and so forth.

As is shown in FIG. 2(d), when “Copy Image Quality Adjustment” is set as a detail item, it is possible to set, Original Document Mode: Characters, Density: Light to Dense, and so forth.

Further, as is shown in FIG. 2(e), when “N in 1” is set as a detail item, it is possible to set, Simplex: 2 in 1, Simplex: 4 in 1, Duplex: 2 in 1, Duplex: 4 in 1, and so forth.

Referring to FIG. 1 again, because the settings as above can be made with the touch panel 51, the display control unit 62 of the control unit 6 is able to measure a time (clock time) at which the user first chooses the display screen of the basic item as the input start time (clock time). Regardless of the hierarchy of the operation performed by the user, when the start key 52 is depressed, all the states set up to this point in time are adopted and the operation of a desired job is executed, and by finding a difference between the depressed time (time clock) of the start key 52 and the input start time (clock time), it is possible to measure a time the user has spent for the operation of the job.

As is shown in FIG. 2, an instruction that the user inputs from the touch panel 51 has a wide variety of instruction contents, including those that can be simply chosen from a pull-down list, such as the original document size, those that need to be directly inputted, such as a file name, those that are easily understandable intuitively, such as the output number and the density, and those that are not easily understandable intuitively, such as N in 1.

Hence, it is impossible to determine whether the user basically needs a support in choosing the capability category by category for each choice by merely measuring the state (in this embodiment, by measuring a time).

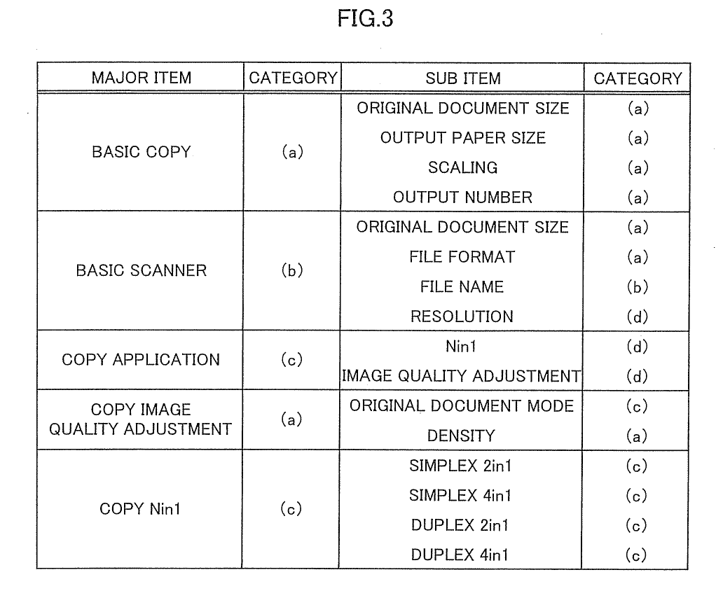

FIG. 3 is a view showing an example of items and the classification of categories on the screen of the touch panel shown in FIG. 2.

FIG. 3 shows main items that are basic items and sub-items that are fine adjustment items displayed on the touch panel of FIG. 2 by dividing them into categories.

Herein, regarding the content of each category, (a) indicates the category for which the item can be understood and the item can be inputted with ease, (b) indicates the category for which the item can be understood easily whereas an input of the item takes longer, (c) indicates the category for which the item cannot be understood easily whereas an input of the item is easy, and (d) indicates those other than the categories (a), (b), and (c) described above.

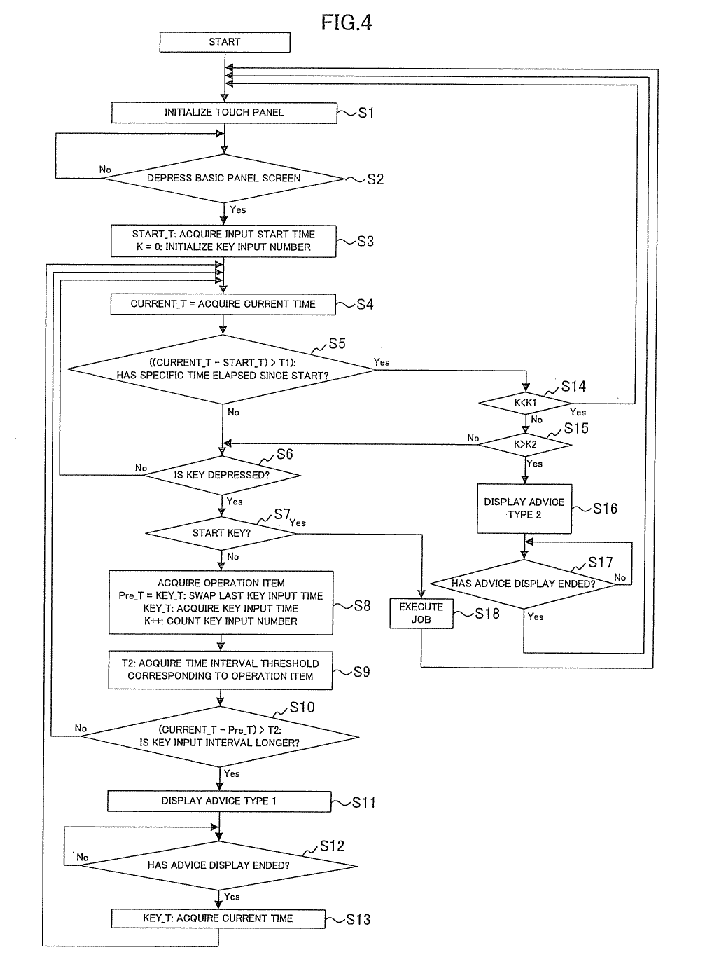

FIG. 4 is a flowchart showing the flow of operations of the display control unit 62 in the image processing apparatus of the first embodiment shown in FIG. 1, and it shows the flow of operations of the display control unit 62 when any of the categories shown in FIG. 3 is used. Hereinafter, the flow of operations of the display control unit 62 will be described with reference to FIG. 4.

Initially, after the display control unit 62 initializes the touch panel 51 (Step S1), it stands by until the screen of the basic panel is operated by means of depression (Step S2). When the basic panel is operated, it assumes that the operation of a job is started (Step S2, Yes), and acquires the input start time START_T and further initializes the key input number by resetting the counter K of the key input number to 0 (Step S3).

Subsequently, it acquires the current time CURRENT_T (Step S4), finds a difference between the input start time START_T and the current time CURRENT_T, and compares the difference with a threshold T1 of an elapsed time (Step S5).

In a case where the difference between the input start time START_T and the current time CURRENT_T is found to be less than the threshold T1 of the elapsed time (Step S5, No), it stands by while updating the current time until the start key 52 or any other key is depressed (Step S6).

In a case where the start key 52 is depressed (Step S7, Yes), it executes the set job (Step S18), and returns to the start state in Step S1 (the initialization of the touch panel), and repeats the processing described above thereafter.

Meanwhile, in a case where the start key 52 is not depressed and instead any other key is depressed in Step S7 (Step S7, No), it acquires the item the user is currently operating, the time and the key input number.

For example, the operation item, swap of the last key input time: Pre_T=Key_T, the key input time: Key_T, and the count of input number: K++ are acquired (Step S8).

Further, it acquires a time interval threshold T2 between key inputs that corresponds to the operation item (Step S9).

The time interval threshold T2 has a set value for each category shown in FIG. 3 that is read from an LUT or the like. Herein, whether the time interval of key inputs (CURRENT_T−Pre_T) is longer than the time interval threshold T2 is determined (Step S10).

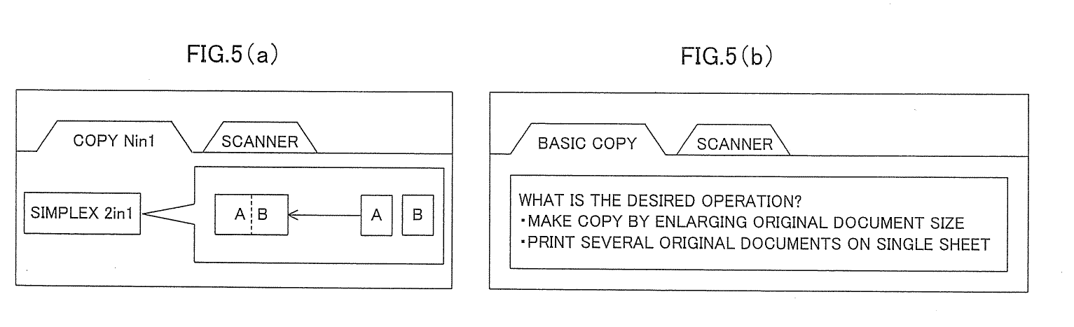

In a case where the time interval of the key inputs is found to be longer than the time interval threshold value T2 In Step S10 (Step S10, Yes), it determines that the user is in trouble with operations, and displays Advice Type 1 of FIG. 5(a) relating to the item being currently operated (Step S11).

FIG. 5 shows a display screen of the advice type displayed, for example, on the touch panel 51 of the image processing apparatus of FIG. 1. FIG. 5(a) shows a display example of Advice Type 1 and FIG. 5(b) shows a display example of Advice Type 2.

For example, as is shown in FIG. 5(a), in the case of Simplex 2 in 1, a support screen indicating that two original documents A and B can be copied into a single sheet of paper is displayed.

Meanwhile, in a case where the time interval of key inputs is found to be shorter than the time interval threshold T2 in Step S10 (Step S10, No), it determines that the user is not in trouble and returns to Step S4 to shift to a state where it waits for a next key input to repeat the processing described above.

Subsequently, it determines whether the display of Advice Type 1 has ended (Step S12), and when the display of Advice Type 1 ends (Step S12, Yes), it stores the current time to the key input time (KEY_T) (Step S13), and returns to Step S4 to be in a state where it waits for a next key input in the same manner as above.

In a case where a difference between the input start time START_T and the current time CURRENT_T is found to be longer than the threshold T1 of the elapsed time in Step S5, that is, when the elapsed time since the start of the input is longer than the threshold T1 (Step S5, Yes), it determines whether the key input number K is smaller than a first specific number K1 (Step S14). In a case where the key input number K is found to be smaller than the first specific number K1 (Step S14, Yes), it determines that the user has abandoned the operation of the job, and returns to Step S1 to shift to a state where it waits for an acceptance of a new job by initializing the touch panel.

Meanwhile, in a case where the key input number K is found to be greater than the first specific number K1 in Step S14 (K<K1)(Step S14, No), it determines whether the key input number K is greater than a second specific number K2 (Step S15). In a case where the key input number K is found not to be greater than the second specific number K2 (Step S15, No), it returns to Step S6 to repeat the processing described above.

Meanwhile, in a case where the key input number K is found to be greater than the second specific number K2 in Step S15 (Step S15, Yes), it determines that the user needs advice in the upper hierarchy rather than advice of the capability per se, and displays Advice Type 2 of FIG. 5(b) (Step S16). It then determines whether the display of Advice Type 2 has ended (Step S17), and when the display of Advice Type 2 ends (Step S17, Yes), it returns to Step S1 to shift to a state where it waits for an acceptance of a new job by initializing the touch panel.

Regarding the determination in Step S16, it determines that the user is facing a problem, for example, which capability should be chosen for the operation he wishes to use and where the corresponding capability is present. In the example of Advice Type 2 shown in FIG. 5(b), for a question asking the user which operation in the basic copy he wishes to perform, the user is able to make a choice from pieces of advice: make a copy by enlarging the original document size, or print several original documents onto a single sheet.

Advice Type 1 shown in FIG. 5(a) is advice for the capability of N in 1, and it is a display to provide advice as to what should be chosen intuitively by displaying images of input original documents and an outcome of the final output. Such a display is unnecessary for a user who well understands the contents of the capabilities. However, advice that uses an image as shown in FIG. 5(a) appropriately is quite useful for a user who does not know the content of the capabilities.

In addition, as is shown in FIG. 5(b), because Advice Type 2 displays the job content the user wishes to perform in the form of question for the user to make a choice, it is quite useful in a case where the absence or presence of the capability and an operation the user wishes to perform are not readily linked with the capability.

The flowchart of FIG. 4 described the configuration in which the basic panel is depressed without fail before the start key 52 is depressed. It is obvious, however, that a configuration in which the start key 52 alone is inputted is possible. In addition, a calculation is performed simply for the time intervals of key inputs. However, by changing the calculation method or thresholds according to a key input within the list of items (for example, the major items of FIG. 3) or the key input within individual items (for example, the sub-items of FIG. 3), it is possible to provide more accurate advice.

Depending on the items, it is possible to provide advice using a sound for advice to be provided without confusion.

As has been described, in the image processing apparatus of the first embodiment, the instruction unit (instruction means) provides plural operation instructions to the user by displaying plural operation screens or plural operation items according to the operations of the user I/F unit 5a and the control unit 6 of FIG. 1.

The operation screen in this instance is the touch panel screen as shown in FIG. 2, and the operation items are of the content like the example of items and the category classifications as shown in FIG. 3.

The operation skill level calculation unit (operation skill level calculation means) calculates the user's level of skill for an operation instructed by the instruction unit (instruction means) on the basis of operations by the user for each operation screen or operation item displayed by the instruction unit (instruction means) by the processing in Steps S3 through S10 and Steps S14 and S15 in the flowchart of FIG. 4.

Further, the operation support unit (operation support means) provides a support of the operation instructed by the instruction unit (instruction means) according to the level of skill for an operation calculated by the operation skill level calculation unit (operation skill level calculation means) by the processing in Steps S11 and S16 in the flowchart of FIG. 4. In this instance, the operation support unit (operation support means) provides an appropriate support by displaying Advice Type 1 as in FIG. 5(a) or Advice Type 2 as in FIG. 5(b).

Also, the operation skill level calculation unit (operation skill calculation means) calculates the user's level of skill for operation according to the time interval between at least two operations by the user detected by the operation interval detection unit (operation interval detection means) by the processing in Step S8 in the flowchart of FIG. 4.

Further, the operation skill level calculation unit (operation skill level calculation means) calculates the user's level of skill for operation according to the number of operations by the user within a specific time detected by the operation number detection unit (operation number detection means) by the processing in Steps S14 and S15 in the flowchart of FIG. 4.

The operation support unit (operation support means) provides supports of different types according to the user's level of skill for operation calculated by the operation skill level calculation unit (operation skill level calculation mean) by the processing in Steps S11 and S16 in the flowchart of FIG. 4. The supports of different types provided by the operation support unit (operation support means) in this instance are Advice Type 1 of FIG. 5(a) and Advice Type 2 of FIG. 5(b).

As has been described, in the image processing apparatus of the first embodiment, it is possible to provide operation advice without disturbing the operation by the user by determining a length of key operation time for each capability, which can in turn improve the operation throughput of the user markedly. It should be noted, however, that the operation items and the flow of the operation control are not limited to those described above in this embodiment.

### Second Embodiment

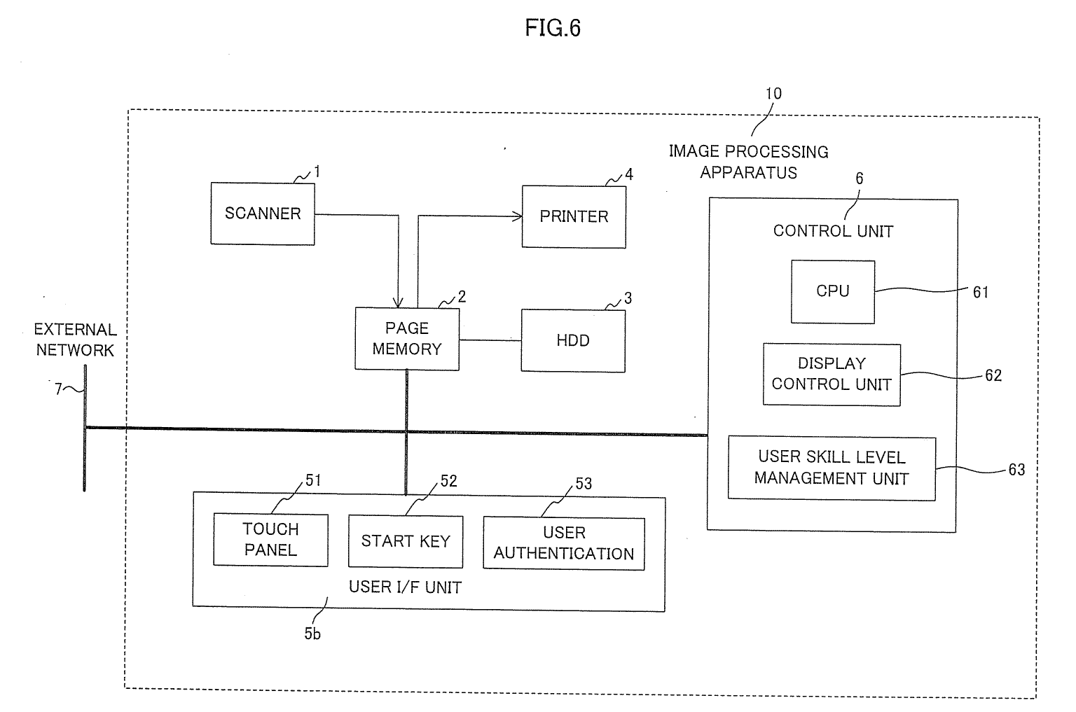

FIG. 6 is a view showing the configuration of an image processing apparatus according to a second embodiment of the invention. The image processing apparatus of the second embodiment shown in FIG. 6 is different from the image processing apparatus of the first embodiment shown in FIG. 1 in that a user authentication unit 53 is added to a user I/F unit 5b. Hence, the operations are basically the same as those in the first embodiment except that the display content of the touch panel 51 and the operation of the display control unit 62 are slightly different.

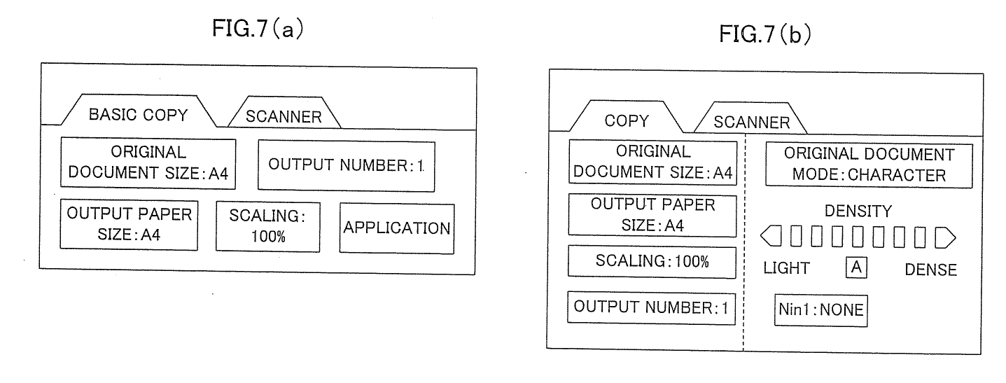

The user authentication unit 53 can be any means as long as it is able to identify the operator, such as existing fingerprint matching or a key input of user ID. Because the operator is identified by the user authentication unit 53, the display control unit 62 acquires the level of skill corresponding to the user ID assigned to each operation and held in the MFP according to the input user ID, and as is shown in FIG. 7, it switches the display contents on the touch panel 51 according to the level of skill, such as the one for a less experienced user and the one for a well experienced user. In other words, FIG. 7 shows screen displays of Advice Types for each level of skill displayed by the display control unit 62 in the image processing apparatus of FIG. 6. FIG. 6(a) shows an example of the display for a less experienced user and FIG. 6(b) shows an example of the display for a well experienced user.

Regarding a method for switching the display screens by the level of skill, the display content is configured as follows. For example, as is shown in FIG. 7(a), for a less experienced user, a large volume of information is not displayed at a time and information is displayed to enable a choice in a hierarchical fashion. For a well experienced user, because he understands the entire capabilities furnished to the MFP and the capabilities that can be combined, as is shown in FIG. 7(b), a large volume of information is displayed at a time to allow the user to choose a desired operation with ease.

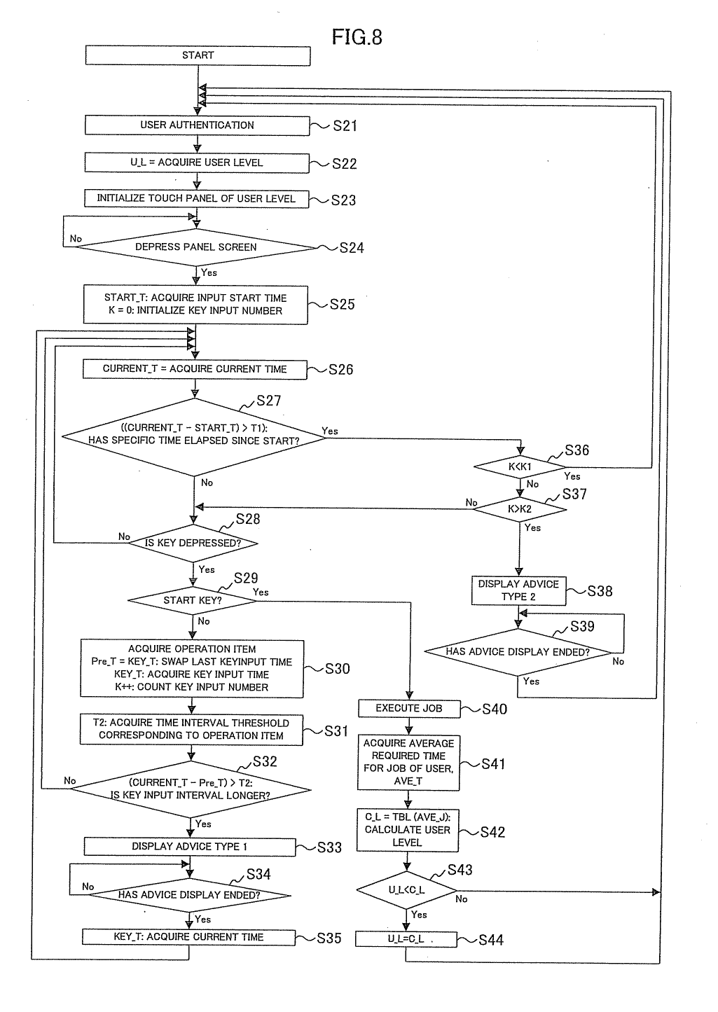

FIG. 8 is a flowchart detailing the flow of operations of the display control unit 62 in the image processing apparatus of the second embodiment shown in FIG. 6.

Initially, the user authentication unit 53 executes a user authentication, (Step S21), and it acquires the current level (U_L), which is the current level of skill of the user (Step S22). It then initializes the touch panel shown in FIG. 7 according to the current level of the user (Step S23). When a key input of some kind is performed as the screen of the touch panel 51 is depressed (Step S24), it assumes that the operation of the job is started (Step S24, Yes), and acquires the input start time START_T and further initializes the key input number by resetting the counter K of the key input number to 0 (Step S25).

Subsequently, it acquires the current time CURRENT_T (Step S26), finds a difference between the input start time START_T and the current time CURRENT_T, and compares the difference with a threshold T1 of an elapsed time (Step S27).

Herein, in a case where the difference between the input start time START_T and the current time CURRENT_T is found to be less than the threshold T1 of the elapsed time, that is, (CURRENT_T−START_T)>T1 is not established (Step S27, No), it stands by while updating the current time until the start key 52 or any other key is depressed (Step S28).

Subsequently, in a case where the start key 52 is not depressed and instead any other key is depressed in Step S29 (Step S29, No), it acquires the item the user is currently operating, the time, and the key input number. More specifically, it acquires the operation item, swap of the last key input time: Pre_T=Key_T, key input time: Key_T, and the count of the input number: K++ (Step S30). Further, it acquires a time interval threshold T2 of the key input time corresponding to the operation item (Step S31).

It determines whether the time interval of key inputs (CURRENT_T−Pre_T) is longer than the time interval threshold T2 (Step S32), and in a case where the former is found not to be longer than the latter (Step S32, No), it returns to Step S26 and repeats the processing described above.

Meanwhile, in a case where the time interval of key inputs is found to be longer than the time interval threshold T2 in Step S32 (Step S32, Yes), it determines that the user is in trouble, and displays Advice Type 1 of FIG. 5(a) relating to the item being currently operated (Step S33).

In a case where the time interval of key inputs is found not to be longer (shorter) than the time interval threshold T2 in Step S32 (Step S32, No), it determines that the user is not in trouble with operations, and returns to Step S26 to shift to a state where it waits for a next key input to repeat the processing described above.

Subsequently, it determines whether the display of Advice Type 1 has ended (Step S34), and when the display of Advice Type 1 ends (Step S34, Yes), it stores the current time in the key input time (KEY_T) (Step S35), and returns to Step S26 to shift to a state where it waits for a next key input in the same manner as above.

In a case where the difference between the input start time START_T and the current time CURRENT_T is found to be longer than the threshold T1 of the elapsed time in Step S27, that is, in a case where an elapsed time since the start of the input is longer than the threshold T1 (Step S27, Yes), it determines whether the key input number K is smaller than a first specific number K1 (Step S36). In a case where the key input number K is found to be smaller than the first specific number K1 (Step S36, Yes), it determines that the user has abandoned the operation of the job, and returns to Step S21 to shift to a state where it waits for an acceptance of a new job by initializing the touch panel.

Meanwhile, in a case where key input number K is found to be greater than the first specific number K1 in Step S36 (Step S36, No), it determines whether the key input number K is greater than a second specific number K2 (Step S37). Herein, in a case where the key input number K is found not to be greater than the second specific number K2 (Step S37, No), it returns to Step S28 to repeat the processing described above.

Meanwhile, in a case where the key input number K is found to be greater than the second specific number K2 in Step S37 (Step S37, Yes), it determines that the user needs advice in the upper hierarchy rather than advice of the capability per se, and displays Advice Type 2 of FIG. 5(b) (Step S38). It then determines whether the display of Advice Type 2 has ended (Step S39), and when the display of Advice Type 2 ends (Step S39, Yes), it returns to Step S21 to shift to a state where it waits for an acceptance of a new job by initializing the touch panel.

The flow described above is almost the same as that of the first embodiment shown in FIG. 4 except that the flow specified below is newly added in the second embodiment shown in FIG. 8. More specifically, in a case where the start key 52 is depressed in Step S29 (Step S29, Yes), the job being set is executed (Step S40).

After the job is executed, it acquires an average required time (AVE_J) of the user from the start to the end of the job (Step S41). The average required time (AVE_J) means a time calculated by averaging the execution times of the current job and several jobs in the past. Hence, by using the average required time (AVE_J), it is possible to make an evaluation by absorbing a variance in operation time of the user.

Subsequently, it calculates a user level (C_L) from TBL using the average required time (AVE_J) as an input (Step S42). Because the operation time becomes shorter as the user becomes more familiar with the operation, the TBL is set so that the user level (C_L) is set to a higher level as the operation time becomes shorter.

Subsequently, it compares the current level (U_L) with the user level (C_L) found by executing the current job (Step S43). In a case where the user level (C_L) is found to be higher than the current level (U_L) and the user level (C_L) is at the higher level (Step S43, Yes), it updates the current level (U_L) to the user level (C_L) (Step S44). Meanwhile, in a case where the user level (C_L) is found to be lower than the current level (U_L) (Step S43, No), it returns to Step S21 to execute a user authentication and repeats the processing described above.

As has been described, once the user level is determined, it is not lowered as an operation using the time measurement as a function, and it is therefore possible to support an operation by the user in a stable manner by absorbing a variety of operations by the user.

For example, when FIG. 7(a) for a less experienced user is suddenly switched to FIG. 7(b) for a well experienced user in the next operation, in other words, the scheme to inquire the user about the change of the user level is introduced into Step S29 of FIG. 8, the user is not able to adapt himself to the operation quickly.

Once the user adapts himself to the operation, the efficiency of an operation can be increased with FIG. 7(b) for a well experienced user than with FIG. 7(a) for a less experienced user; however, the efficiency possibly varies to some extent. Even in such a case, by adding the limiting condition to the update of the user level as in the second embodiment, the operation can be stabilized further.

It is well anticipated that a key input takes a long time when the capability that has not been used is used. In this embodiment, the user level is used to switch the start screens. However, by using the user level for the display of the support information, it is possible to configure in such a manner that the support contents are switched according to the user level of the user by explaining simple capabilities for a less experienced user and explaining a combination of the capabilities for a well experienced user.

In this embodiment, one user level is assigned to one user. However, by configuring in such a manner that the user level is assigned for each capability, it is possible to enhance the convenience for the user.

For example, for the user who has used particular capabilities alone, he is well experienced with the high level of skill for these capabilities, while he is least experienced for the capabilities he has not used. Hence, by recording and managing the level for each capability, he is able to receive a sufficient support for the capabilities he has not used, which improves his operation ability markedly. It should be noted that the operation items and the operation control flow are not limited to those in this embodiment.

As has been described, in the image processing apparatus of the second embodiment, the user identification unit (user identification means) identifies the user who executes an operation by the processing in Step S21 of the flowchart of FIG. 8. The user skill level management unit (users skill level management means) 63 shown in FIG. 6 manages the level of skill of the user calculated by the skill level calculation unit (skill level calculation means) for the identified user in a one-to-one correspondence.

In this instance, the user skill level management unit (user skill level management means) 63 upgrades the level of skill of the user according to the level of skill of the user calculated by the skill level calculation unit by the processing in Step S44 of the flowchart of FIG. 8 and manages the upgraded level of skill.

In addition, the user skill level management unit (user skill level management means) 63 manages the level of the user without degrading the level of skill according to the level of skill of the user calculated by the skill level calculation unit (skill level calculation means) by the processing in Step S43 of the flowchart of FIG. 8.

### Third Embodiment

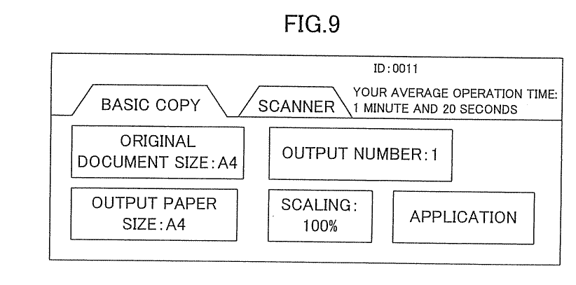

FIG. 9 is a view showing an example of the display on a touch panel of an image processing apparatus according to a third embodiment of the invention. The configuration of the image processing apparatus of the third embodiment is the same as the configuration of the image processing apparatus of the second embodiment shown in FIG. 6.

As is shown in FIG. 9, the operation screen of the touch panel in the case of this embodiment is basically the same as the operation screen of FIG. 7(a) of the second embodiment except that it is configured in such a manner that an average required time of the operator used in Step S41 of FIG. 8 is displayed on the operation screen of the touch panel 51. More specifically, on the operation screen of the touch panel of FIG. 9, “ID: 0011, Your Average Operation Time: 1 minute and 20 seconds” is displayed.

In other words, by providing the operation screen of the touch panel as shown in FIG. 9, the operator is able to understand the subjective operation level of his own at this stage and the required time needed for the operation at a glance, which gives a motivation to improve the operation ability and the user is consequently able to reach the higher operation ability. In other words, in the image processing apparatus of the third embodiment, the user skill level management unit (user skill level management means) 63 displays information about the level of skill for each operator using the display content as shown in FIG. 9.

### Fourth Embodiment

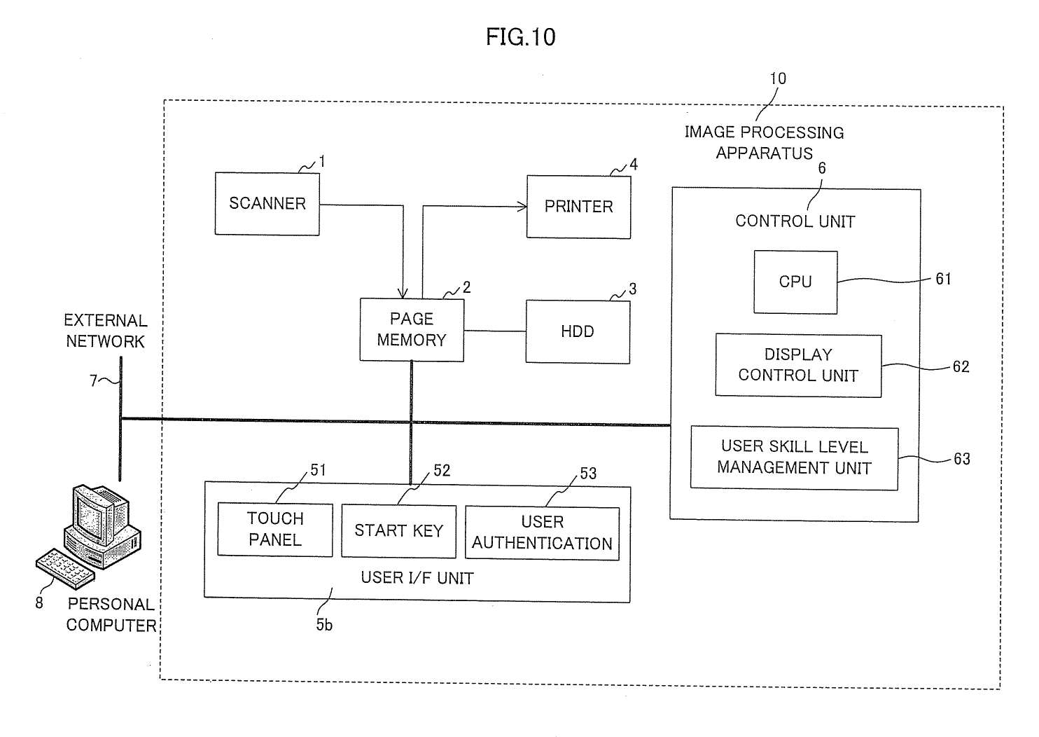

FIG. 10 is a view showing the configuration of an image processing apparatus according to a fourth embodiment of the invention. The image processing apparatus of the fourth embodiment shown in FIG. 10 is different from the image processing apparatus of the second embodiment of FIG. 6 in that a personal computer 8 is connected to the external network 7. Because the configuration other than this is the same as that of the second embodiment, descriptions will not be repeated.

Referring to FIG. 10, the user ID and the average required time for job of the user (AVE_T acquired in Step S41 of FIG. 8) are transmitted from the display control unit 62 to the personal computer 8.

The personal computer 8 manages the average required time for job of each user who uses the corresponding MFP (AVE_T acquired in Step S41 of FIG. 8), and the manager is thus able to provide appropriate advice to an operator who is taking a long time to operate the MFP.

Alternatively, by configuring in such a manner that information managed by the personal computer 8 is sent to the MFP so that the MFP only calculates the current state without managing the average required time for job and the user's current level in the MFP, it is possible to increase the degree of freedom in setting the user level, which can in turn upgrade the level of the management system.

As has been described, according to the image processing apparatus in each embodiment described above, because it is possible to provide an appropriate support to the operator on the basis of an input time to the touch panel and the user authentication, the operation throughput of the user can be improved further.

According to the image processing apparatus of each embodiment described above, because a time is measured for each capability, not only is it possible to calculate the level of skill appropriately to the MFP having multiple capabilities, but it is also possible to provide advice by providing additional information on the display when necessary, which makes it possible to provide support to the user efficiently.

Further, according to the image processing apparatus of each embodiment described above, it is possible to support the user, for example, by a sound capability that provides advice by utilizing means different from a display when necessary. In addition, because a user who fails to achieve the desired capability operation can be identified accurately, it is possible to provide appropriate advice to this user.

Further, because the type of a trouble of the user can be determined on the basis of the operation time, it is possible to provide appropriate advice for a trouble of each type.

According to the image processing apparatus of each embodiment described above, because once the level of skill is determined, basically, the level is never lowered. The user is thus able to perform operations without feeing any stress.

Because the user is able to understand a time needed for him for the operation, a motivation to perform the operation efficiently can be given and the user is consequently able to reach the higher operation ability.

According to the image processing apparatus of each embodiment described above, because a time needed for each person in charge for an operation can be understood, a motivation to perform the operation efficiently can be given and the user is consequently able to reach the higher operation ability.

Further, for all the users of the MFP, a time necessary for a job can be understood for each person in charge, it is possible to understand the use situation for all the users of the MFP, which gives a motivation to improve the operation ability and the user is consequently able to reach the higher operation ability.

According to the image processing apparatus of each embodiment described above, time interval measurements can be changed for each capability or each screen and a clue can be displayed on the display. Alternatively, it is possible to provide a sound support. In addition, the support guide can be activated when the start button is not depressed within a specific time.

The image processing apparatus of each embodiment above is able to determine and display advice of a different type. Further, it is possible to configure so as not to lower the level of skill of the operator once it has been determined; however, it may be configured to lower the level of skill of the operator when the need arises.

The image processing apparatus of each embodiment above is able to calculate an average time of operation times by identifying an operator to be displayed on the control panel, to transmit the average value of the operation times to the server by identifying the operator, and to manage the operation times in the server by identifying the operator.

It is obvious that the instruction means, the operation skill level calculation means, the operation support means, the operation interval detection means, the operation number detection means, and the user identification means described in the embodiments above can be applied to a program that causes a computer to perform the method for supporting an operation of the image processing apparatus described with reference to the flowcharts shown in the embodiments.

The program is recorded in a recording medium readable by the computer, and has the capability to cause the computer to perform the method for supporting an operation of the image processing apparatus of the invention when read by the computer.

The embodiments above described a case where these capabilities are pre-recorded in the apparatus. However, the invention is not limited to this configuration, and the same capabilities may be downloaded to the apparatus from the network, or the same capabilities recorded in a recording medium may be installed in the apparatus. The recording medium can be a recording medium of any format, such as a CD-ROM, as long as it is capable of storing the programs and readable by the apparatus. The capabilities obtained by pre-installment or downloading as described above may be those achieved in cooperation with the OS (Operating System) in the apparatus or the like.

What is claimed is:

1. An image processing apparatus, comprising:
an instruction unit configured to provide plural operation instructions to a user by displaying one of plural operation screens and plural operation items;
an operation skill level calculation unit configured to calculate a level of skill of the user for an operation instructed by the instruction unit for one of each operation screen and each operation item displayed by the instruction unit according to an operation by the user; and
an operation support unit configured to support the operation instructed by the instruction unit according to the level of skill calculated by the operation skill level calculation unit.

2. The image processing apparatus according to claim 1, wherein:
the operation skill level calculation unit includes an operation interval detection unit configured to detect a time interval between at least two operations by the user, and calculates the level of skill of the user according to the interval of the operations detected by the operation interval detection unit.

3. The image processing apparatus according to claim 1, wherein:
the operation skill level calculation unit includes an operation number detection unit configured to detect the number of operations by the user within a specific time and calculates the level of skill of the user according to the number of operations detected by the operation number detection unit.

4. The image processing apparatus according to claim 1, wherein:
the support unit provides a support of a different type by the level of skill of the user calculated by the operation skill level calculation unit.

5. The image processing apparatus according to claim 1, further comprising:
a user authentication unit configured to identify a user who performs an operation; and
a user skill level management unit configured to manage the level of skill of the user calculated by the skill level calculation unit for each user.

6. The image processing apparatus according to claim 5, wherein:
the user skill level management unit switches operation screens for an operation according to the level of skill of the user calculated by the skill level calculation unit.

7. The image processing apparatus according to claim 5, wherein:
the user skill level management unit displays information about the level of skill for each user who performs an operation.

8. The image processing apparatus according to claim 5, further comprising:
an interface with an external device,
wherein information about the level of skill of each user is transmitted via the interface.

9. An image processing apparatus, comprising:
instruction means for providing plural operation instructions to a user by displaying one of plural operation screens and plural operation items;
operation skill level calculation means for calculating a level of skill of the user for an operation instructed by the instruction means for one of each operation screen and each operation item displayed by the instruction means according to an operation by the user; and
operation support means for supporting the operation instructed by the instruction means according to the level of skill calculated by the operation skill level calculation means.

10. The image processing apparatus according to claim 9, wherein:
the operation skill level calculation means includes operation interval detection means for detecting a time interval between at least two operations by the user, and calculates the level of skill of the user according to the interval of the operations detected by the operation interval detection means.

11. The image processing apparatus according to claim 9, wherein:
the operation skill level calculation means includes an operation number detection means for detecting the number of operations by the user within a specific time and calculates the level of skill of the user according to the number of operations detected by the operation number detection means.

12. The image processing apparatus according to claim 9, wherein:
the operation support means provides a support of a different type by the level of skill of the user calculated by the operation skill level calculation means.

13. The image processing apparatus according to claim 9, further comprising:
user authentication means for identifying a user who performs an operation; and
user skill level management means for managing the level of skill of the user calculated by the skill level calculation means for each user.

14. The image processing apparatus according to claim 13, wherein:
the user skill level management means switches operation screens for an operation according to the level of skill of the user calculated by the skill level calculation means.

15. The image processing apparatus according to claim 13, wherein:
the user skill level management means displays information about the level of skill for each user who performs an operation.

16. The image processing apparatus according to claim 13, further comprising:
interface means with an external device, wherein information about the level of skill of each user is transmitted via the interface means.

17. A method for supporting an operation of an image processing apparatus that causes a computer in the image processing apparatus to provide a support of an operation of the image processing apparatus, comprising the steps of:
providing plural operation instructions to a user by displaying one of plural operation screens and plural operation items;
calculating a level of skill of the user for an operation instructed in the step of providing instructions for one of each operation screen and each operation item; and
supporting the operation instructed in the step of providing instructions according to the level of skill calculated in the step of calculating the operation skill level.

18. The method for supporting an operation of an image processing apparatus according to claim 17, wherein:
in the step of calculating the level of skill for the operation includes a step of detecting a time interval between at least two operations by the user, and the level of skill of the user is calculated according to the interval of the operations detected in the step of detecting the time interval.

19. The method for supporting an operation of an image processing apparatus according to claim 17, wherein:
the step of calculating the level of skill of the operation includes the step of detecting the number of operations by the user within a specific time and the level of skill of the user is calculated according to the number of operations detected in the step of detecting the number of operations.

20. The method for supporting an operation of an image processing apparatus according to claim 17, wherein:
in the step of providing the support, a support of a different type is provided by the level of skill of the user calculated in the step of calculating the level of skill for the operation.
